(19) United States
(12) Patent Application Publication
(10) Pub. No.: US 2012/0257487 A1
(43) Pub. Date: Oct. 11, 2012

(54) OPTICAL DISC DRIVE

(75) Inventors: Hiroaki Matsumiya, Osaka (JP); Kazuo Momoo, Osaka (JP)

(73) Assignee: PANASONIC CORPORATION, Osaka (JP)

(21) Appl. No.: 13/377,946

(22) PCT Filed: Apr. 8, 2011
(86) PCT No.: PCT/JP2011/002099

§ 371 Date: Dec. 13, 2011

(51) Int. Cl. G11B 7/135; G11B 7/1263; G11B 7/127

(52) U.S. Cl. 369/112.01; G9B/7.1; G9B/7.103; G9B/7.112

(57) ABSTRACT

An optical disc drive according to the present invention includes: a laser light source 2 for emitting a laser beam; a photodetector 10 for detecting a signal that has been supplied from an optical disc 100; and an optical system 200 for irradiating the optical disc 100 with the laser beam and guiding the light reflected from the optical disc 11 to the photodetector 10. The drive further includes a memory 300 for storing information defining a relation between the output value of the photodetector 10 and the output power of the laser light source 2 when the laser light source 2 is emitting the laser beam but the light reflected from the optical disc 100 fails to reach the photodetector 10; and a control section 400 for controlling the output power of the laser light source 2 based on the information stored in the memory 300 and the output of the photodetector 10 when the laser light source 2 is emitting the laser beam but the light reflected from the optical disc fails to reach the photodetector 10.

### TECHNICAL FIELD

The present invention relates to an optical disc drive for reading data optically from an optical disc by using a laser light source, and also relates to an optical disc drive for reading and writing data optically from/on an optical disc by using a laser light source.

### BACKGROUND ART

In optical disc technologies, data can be read out from a rotating optical disc by irradiating the disc with a relatively weak light beam with a constant intensity and detecting the light that has been modulated by, and reflected from, the optical disc. On a read-only optical disc, information is already stored as pre-pits that are arranged either concentrically or spirally during the manufacturing process of the optical disc. On the other hand, on a rewritable optical disc, a recording material film, from/on which data can be read and written optically, is deposited by evaporation process, for example, on the surface of a substrate on which concentric or spiral grooves are arranged. In writing data on a rewritable optical disc, data is written there by irradiating the optical disc with a pulsed light beam, of which the optical power has been changed according to the data to be written, and locally changing the property of the recording material film.

In a recordable or rewritable optical disc, when data is going to be written on its recording material film, the recording material film is irradiated with such a light beam, of which the optical power has been modulated as described above, thereby recording an amorphous mark on a crystalline recording material film. Such an amorphous recorded mark is left there by heating a portion of the recording material film that has been irradiated with a writing light beam to a temperature that is equal to or higher than its melting point and then rapidly cooling that portion. If the optical power of a light beam that irradiates the recorded mark is set to be relatively low, the temperature of the recorded mark being irradiated with the light beam does not exceed its melting point and the recorded mark will turn crystalline again after having been cooled rapidly (i.e., the recorded mark will be erased). In this manner, the recorded mark can be rewritten over and over again. However, if the power of the laser beam emitted from the light source for writing data had an inappropriate level, then the recorded mark would have a deformed shape and sometimes it could be difficult to read the data as intended.

It should be noted that the depth of the pits and tracks and the thickness of the recording material film are both smaller than the thickness of the optical disc. For that reason, those portions of the optical disc, where data is stored, define a two-dimensional plane, which is sometimes called an “information storage plane” or an “information plane”. However, considering that such a plane actually has a physical dimension in the depth direction, too, the term “information storage plane (or information plane)” will be replaced herein by another term “information storage layer”. Every optical disc has at least one such information storage layer. Optionally, a single information storage layer may actually include a plurality of layers such as a phase-change material layer and a reflective layer.

In a high-density optical disc such as a Blu-ray Disc (BD), at least one information storage layer is supported on a substrate and the light incident surface of the information storage layer is covered with a thin protective coating (which is a light-transmitting layer). If a number of information storage layers are stacked one upon the other, then another light-transmitting layer is interposed between each pair of those information storage layers. The depth of an information storage layer in question (i.e., the information storage layer at which the focus of a light beam is currently located) as measured from the light incident surface of such an optical disc (which will be simply referred to herein as “the surface of an optical disc”) is typically 100 μm or less.

To read data that is stored on an optical disc or to write data on a rewritable optical disc, the light beam always needs to maintain a predetermined converging state on a target track on a target information storage layer. For that purpose, a “focus control” and a “tracking control” need to be done. The “focus control” means controlling the position of an objective lens along a normal to the information plane (such a direction will sometimes be referred to herein as “substrate depth direction”) so that the focal point (or at least the converging point) of the light beam is always located on the information storage layer. On the other hand, the “tracking control” means controlling the position of the objective lens along the radius of a given optical disc (which direction will be referred to herein as a “disc radial direction”) so that the light beam spot is always located right on the target track.

In order to perform such a focus control or a tracking control, the focus error or the tracking error needs to be detected based on the light that has been reflected from the optical disc and the position of the light beam spot needs to be adjusted so as to reduce the error as much as possible. The magnitudes of the focus error and the tracking error are respectively represented by a “focus error (FE) signal” and a “tracking error (TE) signal”, both of which are generated based on the light that has been reflected from the optical disc.

An optical disc drive for reading or writing data from/on an optical disc includes an optical pickup as a member for irradiating the optical disc with a light beam and for detecting the light beam that has been reflected from the optical disc. The optical pickup includes a laser light source for emitting a light beam, a photodetector for detecting the reflected light, and an optical system for irradiating the optical disc with the laser beam and for guiding the light reflected from the optical disc to the photodetector.

To perform a read/write operation with good stability, the quantity of the light beam that irradiates the optical disc needs to be controlled to maintain an appropriate level. For that purpose, an optical pickup for a conventional optical disc drive guides a part of the light beam that has been emitted from a laser light source to a monitoring photodetector (which will be referred to herein as a “light quantity detector”) and the output power of the laser light source is controlled based on the output of the light quantity detector.

Hereinafter, an exemplary arrangement for a conventional optical pickup will be described with reference to FIGS. 6 through 8.

First of all, look at FIG. 6, which illustrates an optical pickup that includes a laser light source 2 for emitting a light beam, a beam splitter 4 for either reflecting or transmitting the light beam according to its polarization direction, a light quantity detector 6 on which part of the light beam that has been emitted from the laser light source 2 and then transmitted through the beam splitter 4 is incident, a wave plate 5 for transforming the light beam that has been reflected from the beam splitter 4 into circularly polarized light, an objective lens 8 for converging the light beam that has been transmitted through the wave plate 5 onto a target information storage layer of an optical disc 100, and an optical signal detector 10 for receiving the light beam that has been reflected from the information storage layer of the optical disc 100 and transmitted through the beam splitter 4 (which will be referred to herein as “reflected light”). Such an optical pickup is disclosed in Patent Document No. 1, for example.

The laser light source 2 includes a semiconductor laser diode that emits a polarized light beam. The polarization direction of the light beam that is incident on the beam splitter 4 after having been reflected from the information storage layer of the optical disc 100 has rotated 90 degrees from that of the laser beam that is incident on the beam splitter 4 after having been emitted from the laser light source 2. More specifically, although the laser beam is circularly polarized light when transmitted through the wave plate 5, the laser beam transmitted through the wave plate 5 after having been reflected from the optical disc 100 has turned from the circularly polarized light into linearly polarized light. At this point in time, the polarization direction of the linearly polarized light agrees with the direction of the light that can be transmitted through the beam splitter 4. That is why the beam splitter 2 transmits and reflects the light beam as described above. The dashed line 501 shown in FIG. 6 indicates the optical axis of the laser beam.

The optical pickup shown in FIG. 6 irradiates the information storage layer of the optical disc 100 with a light beam and detects the light that has been reflected from the information storage layer of the optical disc 100 at the optical signal detector 10, thereby reading data from the optical disc 100. Hereinafter, this point will be described in further detail. Part of the light beam that has been emitted from the laser light source 2 is reflected from the beam splitter 4 toward the objective lens 8, transmitted through the objective lens 8, and then focused on the information storage layer of the optical disc 100. Next, the light is reflected from the information storage layer of the optical disc 100, transmitted through the objective lens 8 and the beam splitter 4, and then incident on the optical signal detector 10. As a result of the photoelectric conversion performed by the optical signal detector 10, a signal representing either the intensity or the quantity of the light that has been incident on the optical signal detector is generated. And that signal is used to read the data that is stored on the information storage layer of the optical disc 100. It should be noted that the optical signal detector 10 can also generate a tracking error signal or a focus error signal.

Meanwhile, another part of the light beam that has been emitted from the laser light source 2 is transmitted through the beam splitter 4 and then directly incident on the light quantity detector 6. This is because the light beam that has been emitted from the laser light source 2 and then incident on the beam splitter 4 is not quite linearly polarized light and because the polarized light filtering rate of the beam splitter 4 is not 100%. The light beam that has been emitted from the laser light source 2, transmitted through the beam splitter 4 and then incident on the light quantity detector 6 is photoelectrically converted by the light quantity detector 6, thereby producing an output that represents the quantity of the light beam (i.e., its output power). The output of the light quantity detector 6 is substantially proportional to the quantity of the light beam that has been reflected from the beam splitter 4, transmitted through the objective lens 8, and then focused on the information storage layer of the optical disc 100. In other words, if the quantity of the light beam emitted from the laser light source 2 increases or decreases for some reason, the output of the light quantity detector 6 also increases or decreases. That is why if the laser light source 2 is controlled to keep the output of the light quantity detector 6 constant, the quantity of the light that irradiates the optical disc 100 can also be kept constant.

The introduction of such a light quantity detector 6 into the optical pickup for monitoring purposes, however, would not only interfere with downsizing of the optical pickup but also raise the price of the optical pickup as well. The light quantity detector 6 is usually provided for an optical pickup that performs a write operation as well as a reading operation. This is because the power of a light beam for use to perform a write operation is higher than that of a light beam for use to perform a read operation and the light beam for writing needs to be adjusted with higher precision than the light beam for reading. For that reason, an optical disc drive that can perform both a read operation and a write operation generally controls the power based on the output of the light quantity detector 6 shown in FIG. 6.

Next, another conventional optical pickup will be described with reference to FIG. 7, which illustrates an example of a conventional optical pickup without such a monitoring light quantity detector 6. In the example illustrated in FIG. 7, a light quantity sensor for measuring the power of a light beam emitted is provided inside of the laser light source 12 (see Patent Document No. 2). Hereinafter, a configuration for a laser light source with such a light quantity sensor as disclosed in Patent Document No. 2 will be described with reference to FIG. 8, which schematically illustrates an internal configuration for such a laser light source 12.

The laser light source 12 shown in FIG. 8 includes a semiconductor laser diode 124 and a monitoring light quantity sensor 128, which are integrated together in the same package. Through one of the two end facets (which will be referred to herein as an “emitting end facet”) of the resonant cavity of the semiconductor laser diode 124, emitted is a laser beam 122 for use as a light beam. Meanwhile, through the other end facet (which will be referred to herein as a “rear end facet”) of the resonant cavity of the semiconductor laser diode 124, emitted is a weak laser beam 126 for use as a monitoring light beam. Since an antireflective film has been deposited on the rear end facet of the resonant cavity of the semiconductor laser diode 124, the laser beam transmitted through the rear end facet has a low intensity.

The semiconductor laser diode 124 includes a p-electrode and an n-electrode (neither of which is shown in FIG. 8). A voltage is applied through a wire (not shown) to between those two electrodes of the semiconductor laser diode 124 to make drive current flow through the semiconductor laser diode 124. Then, light, of which the intensity is defined by the amount of that drive current, is produced in the semiconductor laser diode 124. As a result, laser beams 122 and 126 are emitted through those two end facets of the resonant cavity.

A light quantity sensor 128 for detecting the weak laser beam 126 for monitoring is arranged to face the rear end facet of the resonant cavity of the semiconductor laser diode 124. In this case, the quantity of the laser beam 122 being emitted through the emitting end facet of the resonant cavity is proportional to that of the weak laser beam 126 being emitted through the rear end facet. That is why the quantity of the laser beam 122 being emitted through the emitting end facet of the semiconductor laser diode 124 can be determined by the light quantity sensor 128. The optical pickup shown in FIG. 7 controls the output power of the laser light source 12 based on the output of the light quantity sensor 128 (see FIG. 8) of the laser light source 12.

### CITATION LIST

### Patent Literature

Patent Document No. 1: Japanese Patent Application Laid-Open Publication No. 2001-184709
Patent Document No. 2: Japanese Patent Application Laid-Open Publication No. 2007-27372

### SUMMARY OF INVENTION

### Technical Problem

A monitoring light quantity detector and its associated parts are indispensable for the conventional optical pickup shown in FIG. 6. That is why it is difficult to reduce the overall size and manufacturing cost of such an optical pickup.

On the other hand, in the conventional optical pickup shown in FIG. 7, the light quantity sensor 128 and the semiconductor laser diode 124 are integrated together in the same package as shown in FIG. 8. That is why when the semiconductor laser diode 124 generates heat, the temperature of the light quantity sensor 128 changes. Since the output characteristic of the light quantity sensor 128 depends on the temperature, the control of the light quantity based on the output of the light quantity sensor 128 will lose stability, which is a problem.

On top of that, the longer the semiconductor laser diode 124 is used, the more degraded the emitting end facet of the resonant cavity of the semiconductor laser diode 124 gets. As a result, the light quantity ratio of the laser beam 122 to the monitoring light beam 128 will change with time, thus making it difficult to get output control done with stability, which is also a problem.

### Solution to Problem

An optical disc drive according to the present invention includes: a laser light source for emitting a laser beam; a photodetector for detecting a signal that has been supplied from an optical disc; an optical system for irradiating the optical disc with the laser beam and guiding the light reflected from the optical disc to the photodetector; a memory for storing information defining a relation between the output value of the photodetector and the output power of the laser light source when the laser light source is emitting the laser beam but the light reflected from the optical disc fails to reach the photodetector; and a control section for controlling the output power of the laser light source based on the information stored in the memory and the output of the photodetector when the laser light source is emitting the laser beam but the light reflected from the optical disc fails to reach the photodetector.

In one preferred embodiment, the memory stores the output value of the photodetector when the laser beam is emitted by the laser light source but not focused on an information storage layer of the optical disc.

In another preferred embodiment, the memory stores the output value of the photodetector when the laser beam is emitted by the laser light source and when the drive is not loaded with the optical disc.

Another optical disc drive according to the present invention includes: a laser light source for emitting a laser beam; a light quantity sensor for detecting the power of the laser beam; a photodetector for detecting a signal that has been supplied from an optical disc; an optical system for irradiating the optical disc with the laser beam and guiding the light reflected from the optical disc to the photodetector; a memory for storing not only information defining a relation between the output power of the laser light source and the output value of the photodetector but also information defining a relation between the respective outputs of the light quantity sensor and the photodetector when the laser light source is emitting the laser beam but the light reflected from the optical disc fails to reach the photodetector; and a control section for controlling the output power of the laser light source based on the output of the light quantity sensor and the information stored in the memory.

In one preferred embodiment, the control section measures the output value of the photodetector at a certain timing when the laser light source is emitting the laser beam but the light reflected from the optical disc fails to reach the photodetector, and updates the information defining the relation between the respective outputs of the light quantity sensor and the photodetector.

In another preferred embodiment, if the output value of the light quantity sensor is “a” when the laser light source is emitting the laser beam with a first output power and when the light reflected from the optical disc fails to reach the photodetector, the output of the photodetector should be “c” according to the information that is stored in the memory but is actually “b”. In that case, if the difference between “b” and “c” is smaller than a predetermined value, then the output power of the laser light source is controlled so that the output of the light quantity sensor becomes “a′” with respect to the output “c” of the photodetector.

In this particular preferred embodiment, if the difference between “b” and “c” is greater than the predetermined value, then the output power of the laser light source is controlled so that the output of the light quantity sensor becomes “a”.

In another preferred embodiment, the laser light source includes a semiconductor laser diode that produces the laser beam and a package that covers the semiconductor laser diode, and the light quantity sensor is built in the package.

### Advantageous Effects of Invention

According to the present invention, the quantity of the light that irradiates an optical disc can be stabilized and kept constant even without providing an additional built-in light quantity sensor for the optical pickup.

### BRIEF DESCRIPTION OF DRAWINGS

FIG. 1 illustrates the arrangement of major components in an optical disc drive as a first preferred embodiment of the present invention.

FIG. 2 shows how the output of the photodetector changes with the output power in the optical disc drive of the first preferred embodiment of the present invention.

FIG. 3 illustrates an overall configuration for the optical disc drive of the first preferred embodiment of the present invention.

FIG. 4(a) shows how the output of a photodetector 10 changes with the output power of a laser light source 2, FIG. 4(b) shows how the output of a light quantity sensor 128 changes with the output power, and FIG. 4(c) shows how the output of the photodetector 10 changes with that of the light quantity sensor 128.

FIG. 5A illustrates how an output power control may be carried out in an optical disc drive as a second preferred embodiment of the present invention.

FIG. 5B illustrates how an output power control may be carried out in an optical disc drive as a second preferred embodiment of the present invention.

FIG. 6 illustrates an arrangement for a conventional optical pickup.

FIG. 7 illustrates an arrangement for another conventional optical pickup.

FIG. 8 illustrates a detailed configuration of a laser light source for use in either the optical pickup of the present invention or a conventional optical pickup.

FIG. 9A is a flowchart showing the procedure of an output power control to be carried out by the optical disc drive of the second preferred embodiment of the present invention.

FIG. 9B is a flowchart showing the procedure of another output power control to be carried out by the optical disc drive of the second preferred embodiment of the present invention.

### DESCRIPTION OF EMBODIMENTS

### Embodiment 1

Hereinafter, a first preferred embodiment of an optical disc drive according to the present invention will be described.

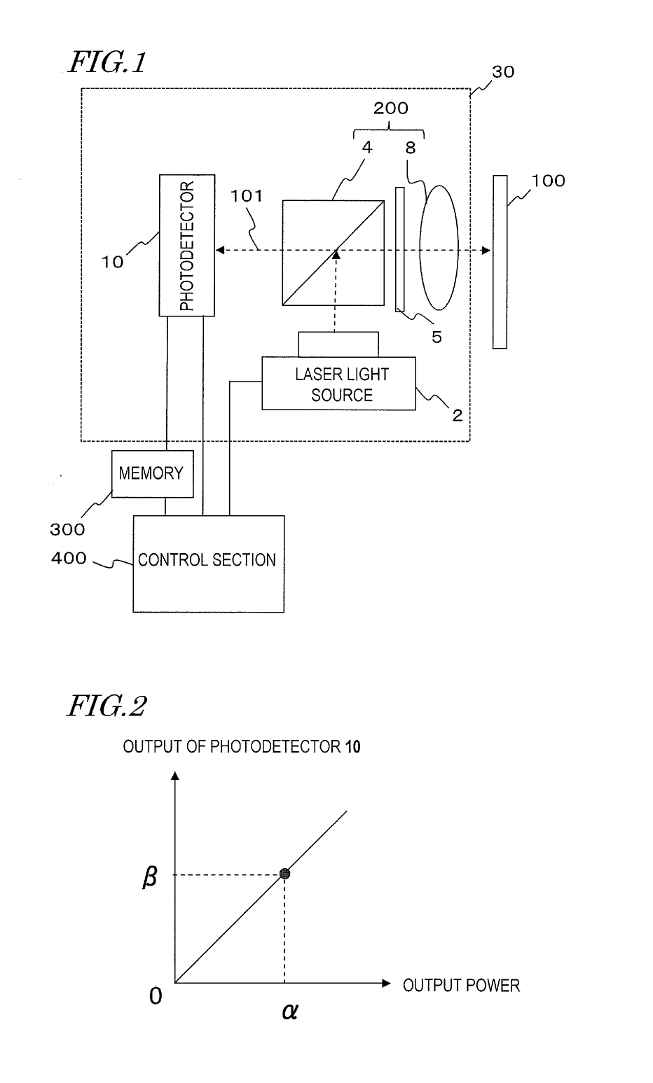

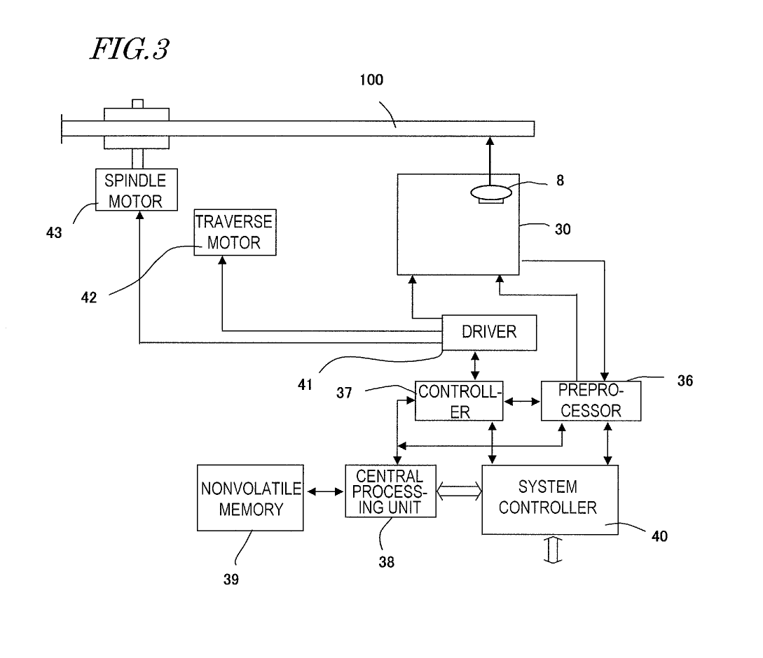

First of all, an arrangement for an optical pickup 30 will be described with reference to FIG. 1. The overall configuration of the optical disc drive will be described later with reference to FIG. 3.

As shown in FIG. 1, the optical disc drive of this preferred embodiment includes an optical pickup 30, a memory 300 and a control section 400. The optical pickup 30 includes a laser light source 2 for emitting a laser beam, a photodetector 10 for detecting a signal that has been supplied from an optical disc 100, and an optical system 200 for irradiating the optical disc 100 with the laser beam and guiding the light reflected from the optical disc 100 to the photodetector 10. The optical system 200 includes a beam splitter 4 for either reflecting or transmitting the light beam according to its polarization direction, a wave plate 5 for transforming the light beam that has been reflected from the beam splitter 4 into circularly polarized light and for transforming the light beam that has been reflected from the optical disc 100 and then transmitted through the objective lens 8 into linearly polarized light, and an objective lens 8 for converging the light beam that has been emitted from the laser light source 2 and then reflected from the beam splitter 4 onto a target information storage layer of an optical disc 100. Although not shown in FIG. 1, the optical pickup 30 further includes an actuator for driving the objective lens 8 and other members.

In the optical disc drive of this preferred embodiment, the memory 300 stores information defining a relation between the output value of the photodetector 10 and the output power of the laser light source 2 when the laser light source 2 is emitting the laser beam but the light reflected from the optical disc 100 fails to reach the photodetector 10. Such a relation is typically a “proportional one” as will be described later. For that reason, if the output power has a certain value α and if the output value of the photodetector 10 is β, the “information defining the relation” may include both of these α and β values or may be the ratio of β to α. Alternatively, if α is either a known value or a fixed value, the “information defining the relation” may be β.

The control section 400 controls the output power of the laser light source 2 by reference to that information stored in the memory 300 and based on the output of the photodetector 10 when the laser light source 2 is emitting the laser beam but the light reflected from the optical disc 100 fails to reach the photodetector 10.

With this optical pickup 30, the light beam that has been emitted from the laser light source 2 and then reflected from the beam splitter 4 is focused by the objective lens 8 onto an information storage layer of the optical disc 100. The light beam is then reflected from the information storage layer of the optical disc 100, transmitted through the objective lens 8 and the beam splitter 4, and then incident on the photodetector 10, which photoelectrically converts the incident light into an electrical signal and outputs a value representing the quantity of the incident light.

Hereinafter, it will be described with reference to FIGS. 1 and 2 how to set the output power.

In the optical pickup 30, when the laser light source 2 is emitting a light beam, the light is reflected unnecessarily somewhere in the optical pickup 30, e.g., by some part of the optical system 200, thus producing stray light. For example, even on the surface of the objective lens 8, the reflectance is not equal to zero. Also, unless the optical disc drive is loaded with an optical disc 100, the light beam that has been transmitted through the objective lens 8 may be partially reflected by the housing of the optical disc drive or some other member thereof. That part of the light that has been reflected from either the objective lens 8 or the housing or some other member of the optical disc drive is then transmitted through the beam splitter 4 and then incident on the photodetector 10. That is why even if the optical disc drive is not loaded with any optical disc 100 yet, part of the light beam that has been emitted from the laser light source 2 turns into stray light and still enters the photodetector 10. Even if the optical disc drive is already loaded with an optical disc 100 but if the light beam has not been focused on any information storage layer of the optical disc 100 yet, the output of the photodetector 10, representing such stray light, can still be detected.

Such stray light is incident on the photodetector 10 and photoelectrically converted there to have a non-zero output value. That is why unless the optical disc drive is loaded with any optical disc 100 or if the light beam is not focused on any information storage layer of the optical disc 100, the output of the photodetector 100 is not equal to zero as long as the laser light source 2 is emitting a light beam. The present inventors discovered that the output of the photodetector 10 representing the stray light is substantially proportional to the output power of the laser light source 2, thereby getting the basic idea of the present invention. That is to say, according to the present invention, the stray light is used intentionally to control the output power of the laser light source based on the output of the photodetector 10, which is usually supposed to be used to generate a signal.

The optical disc drive of this preferred embodiment stores the output value β of the photodetector 10 when the output power is set to be a predetermined value α with no read or write operation performed on the optical disc. This value β represents the stray light to be produced when the value of the output power is α.

As indicated by the solid line in FIG. 2, there is proportionality between the output power and the output of the photodetector representing that stray light. Such a line defining their proportionality is determined based on the value α of the output power and the output value β of the photodetector 10 representing the stray light, which have been measured as described above. In the memory 300, stored is information defining that proportionality (e.g., the gradient of the line). Alternatively, that information may also be a table showing the correspondence between the output power and the output of the photodetector. It should be noted that the memory 300 does not always have to be arranged inside of the optical pickup 30.

According to this preferred embodiment, in a mode of operation in which a read or write operation is performed on the optical disc 100, the focus control on an information storage layer of the optical disc 100 is suspended preferably at regular intervals. Nevertheless, even while the read or write operation is suspended, the laser light source 2 still continues emitting a light beam. In that case, the light is not reflected from the optical disc 100 but stray light will be incident on the photodetector 10. That is why based on the output of the photodetector 10 while the read or write operation is suspended, the output power of the laser light source 2 can be adjusted. This point can be explained as follows with reference to FIG. 2.

Suppose in the read or write operation, the α value described above is the target value of the output power of the laser light source. In that case, the output value of the photodetector 10 while the read or write operation is suspended should be β. However, if the output value of the photodetector 10 is smaller than β, it means that the output power value of the laser light source 2 has become smaller than α. That is why the output power may be changed continuously until the output value of the photodetector 10 gets equal to β. More specifically, the output power of the laser light source 2 may be increased little by little. In that case, every time the output power is increased, the output of the photodetector 10 may be measured. And if the output of the photodetector 10 becomes slightly greater than β, the output power of the laser light source 2 may stop being increased. Alternatively, by making calculations based on the difference between the output value of the photodetector 10 and β and the value of a factor of proportionality, it may also be determined how much the output power of the laser light source 2 needs to be changed. It should be noted that the output power of the laser light source 2 can be controlled by regulating the amount of the drive current of a semiconductor laser diode that the laser light source 2 has. Generally speaking, the larger the amount of drive current supplied, the higher the output power. And the smaller the amount of the drive current supplied, the lower the output power.

Hereinafter, an overall configuration for an optical disc drive according to this preferred embodiment will be described with reference to FIG. 3.

The optical disc drive of this preferred embodiment includes an optical pickup 30, a spindle motor 43 for rotating an optical disc 100, a traverse motor 42 for controlling the position of the optical pickup 30, and a control section for controlling the operations of all of these members. The optical pickup 30 is connected to a preprocessor 36 for performing signal processing and to a driver 41 for controlling the operation of the optical pickup 30 and exchanges electrical signals with them.

Data that has been read optically from the optical disc 100 is converted by the photodetector 10 (see FIG. 1) of the optical pickup 30 into an electrical signal, which is supplied to the preprocessor 36 by way of a signal connector (not shown). The preprocessor 36 generates servo signals, including a focus error signal and a tracking error signal, based on the electrical signal that has been supplied from the optical pickup 30 and performs waveform equalization, binarization slicing and analog signal processing such as synchronous data generation on the read signal.

The servo signals that have been generated by the preprocessor 36 are supplied to the controller 37, which controls the driver 41 so that the light beam spot formed by the optical pickup 30 keeps up with the optical disc 100 rotating. The driver 41 is connected to the optical pickup 30, the traverse motor 42 and the spindle motor 43. The driver 41 gets a series of control operations, including the focus control and tracking control using the objective lens 8, a transport control, and a spindle motor control, done as digital servo operations. That is to say, the driver 41 works so as to drive an actuator (not shown) for the objective lens 8, the traverse motor 42 for moving the optical pickup 30 either inward or outward with respect to the optical disc 100, and the spindle motor 43 for rotating the optical disc 100 appropriately.

The synchronous data that has been generated by the preprocessor 36 is subjected to digital signal processing by a system controller 40, and read/write data is transferred to a host by way of an interface circuit (not shown). The preprocessor 36, the controller 37 and the system controller 40 are connected to a central processing unit (CPU) 38 and operate under the instruction given by the CPU 38. A program that defines a series of operations, including control operations for rotating the optical disc 100, moving the optical pickup 30 to a target location, forming a light beam spot on a target track on the optical disc 100, and making the light beam spot follow the target track, is stored in advance as firmware in a semiconductor storage device such as a nonvolatile memory 39. Such firmware is retrieved from the nonvolatile memory 39 by the CPU 38 according to the mode of operation required.

The preprocessor 36, the controller 37, the CPU 38, the nonvolatile memory 39 and the system controller 40 together functions as a control section 400.

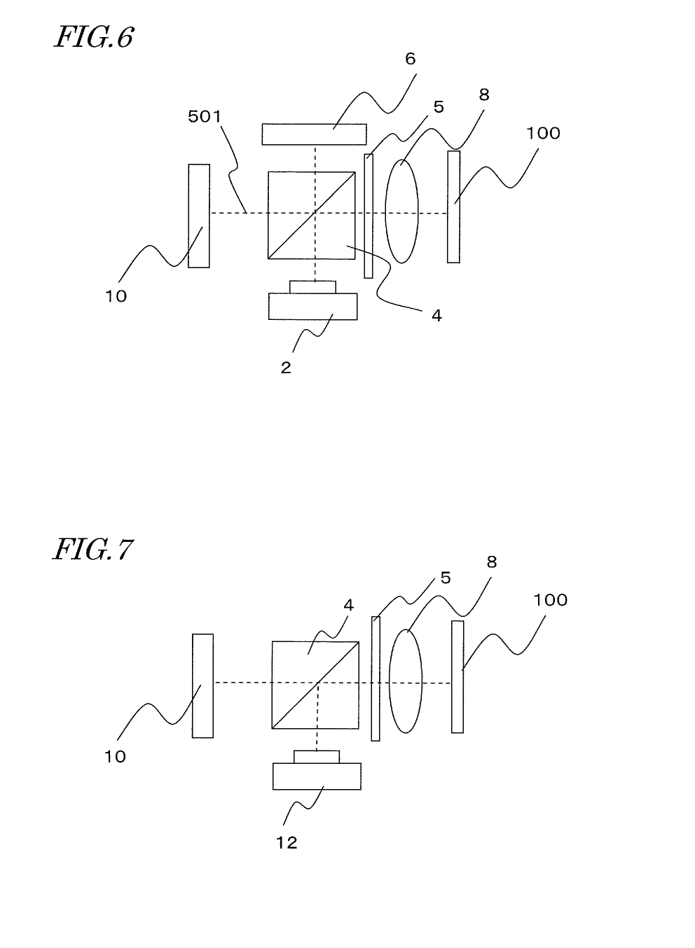

According to this preferred embodiment, as the light quantity detector 6 shown in FIG. 6 is no longer necessary, the output power of the laser beam can still be controlled with high precision even with an inexpensive, small read-only optical pickup for players. That is why such an optical pickup for players can also be used to write data, even though normally a high precision control of the output power should be done to do that. It should be noted that such an optical pickup for players ordinarily uses a semiconductor laser diode with low output power because the output power of such an optical pickup does not have to be high enough to write data. Nevertheless, even if the output power is relatively low, data can still be written on an optical disc. For example, according to the technique disclosed in PCT/JP2010/007, data can still be written with relatively low output power because a mark to record is relatively long.

### Embodiment 2

Next, a second preferred embodiment of an optical disc drive according to the present invention will be described.

The optical disc drive of this preferred embodiment basically has the same configuration as its counterpart of the first preferred embodiment described above (see FIGS. 1 and 3). According to this preferred embodiment, however, the output power of the laser light source 2 is controlled differently from the preferred embodiment described above. Thus, the common features shared by the optical disc drive of this preferred embodiment and its counterpart of the first preferred embodiment described above in terms of their configuration and operation will not be described all over again to avoid redundancies.

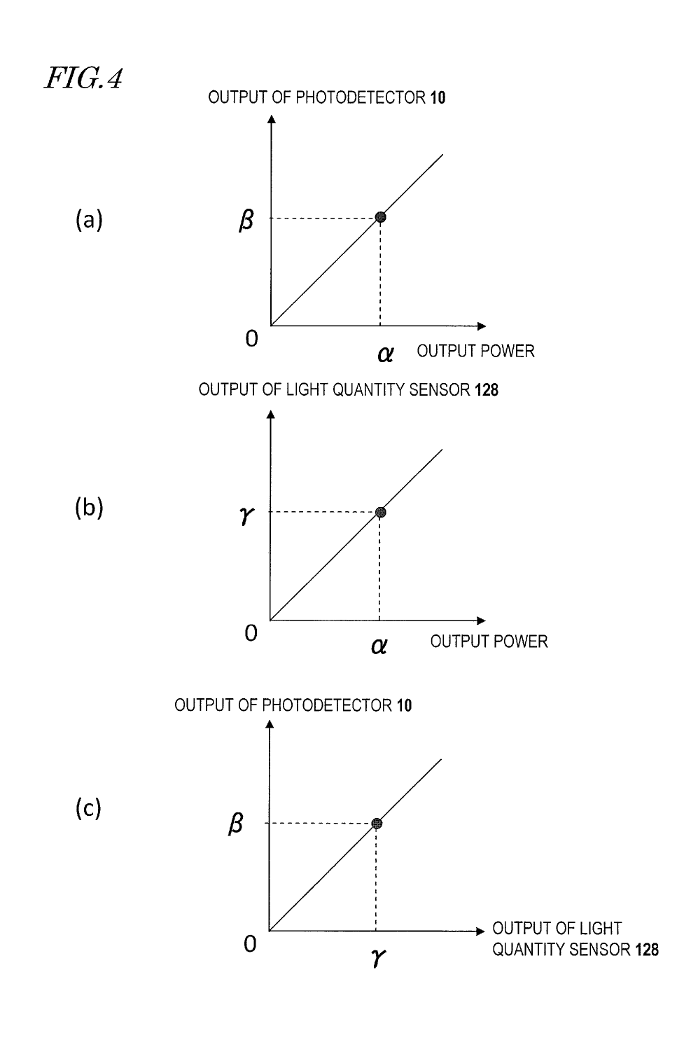

Hereinafter, it will be described with reference to FIGS. 1 and 4 how to control the output power of the laser light source 2 according to this preferred embodiment.

As in the first preferred embodiment described above, while no read or write operation is being performed on the optical disc 100 yet, the output power of the laser light source 2 is also set according to this preferred embodiment to be a predetermined value α, and the output value β of the photodetector 100 at that point in time is stored in the memory 300. In this manner, the relation between the output power and the output of the photodetector is defined as indicated by the solid line in FIG. 4(a). As described above, it is because stray light, which has been produced due to reflection inside the optical pickup 30, enters the photodetector 10 that the output of the photodetector 10 is not zero even when no light reflected from the optical disc 100 is incident on the photodetector 10. The intensity of such stray light is substantially proportional to the output power of the laser light source 2.

In the conventional optical pickup, the laser light source 2 includes a light quantity sensor 128, which is built in a package (i.e., housing) that covers the semiconductor laser diode 124 as shown in FIG. 8. The optical pickup of the first preferred embodiment described above needs no such light quantity sensor 128. According to this preferred embodiment, however, the light quantity sensor 128 included in such an ordinary laser light source 2 is used.

According to this preferred embodiment, when the output of the photodetector 10, representing the stray light described above, is measured, the output value γ of the light quantity sensor 128 that is built in the laser light source 2 is also stored. In this manner, the relation between the output power of the laser light source 2 and the output of the light quantity sensor 128 is defined as indicated by the solid line in FIG. 4(b).

When the respective relations shown in FIGS. 4(a) and 4(b) are defined, the relation between the value β of the photodetector 10 and the output value γ of the light quantity sensor 128 is also obtained as indicated by the solid line in FIG. 4(c).

Next, modes of operation of this optical disc drive, including a read/write operation on an optical disc, will be described.

First of all, when a read or write operation is being performed on an optical disc, the laser light source 2 is controlled so that the output of its light quantity sensor 128 has a desired value. The output of the light quantity sensor 128 may be measured at any time without suspending the read/write operation on the optical disc. That is to say, even if the light reflected from the optical disc 100 is incident on the photodetector 10, the output of the light quantity sensor 128 can also be obtained. For that reason, there is no need to suspend the read/write operation and detect the stray light in order to sense the light quantity and control the output power.

The relation between the respective outputs of the photodetector 10 and the light quantity sensor 128 should satisfy the relation that has been defined in advance as shown in FIG. 4(c). However, the output of the light quantity sensor 128 varies as the temperature of the laser light source changes, and therefore, their actual relation could be different from what has been defined in advance as shown in FIG. 4(c). For that reason, such a variation is preferably detected on a regular or irregular basis.

According to this preferred embodiment, in order to detect such a variation and update the information that is stored in the memory, a focus control on an information storage layer of the optical disc is suspended at a certain timing, thereby preventing the light reflected from the information storage layer from being incident on the photodetector 10. In this case, the “certain timing” may be either a regular interval (of 10 seconds to 1 minute, for example) or before or after the optical disc drive performs a particular operation. After the stray light has gotten ready to enter the photodetector 10 in this manner, the respective outputs of the photodetector 10 and the light quantity sensor 128 are measured.

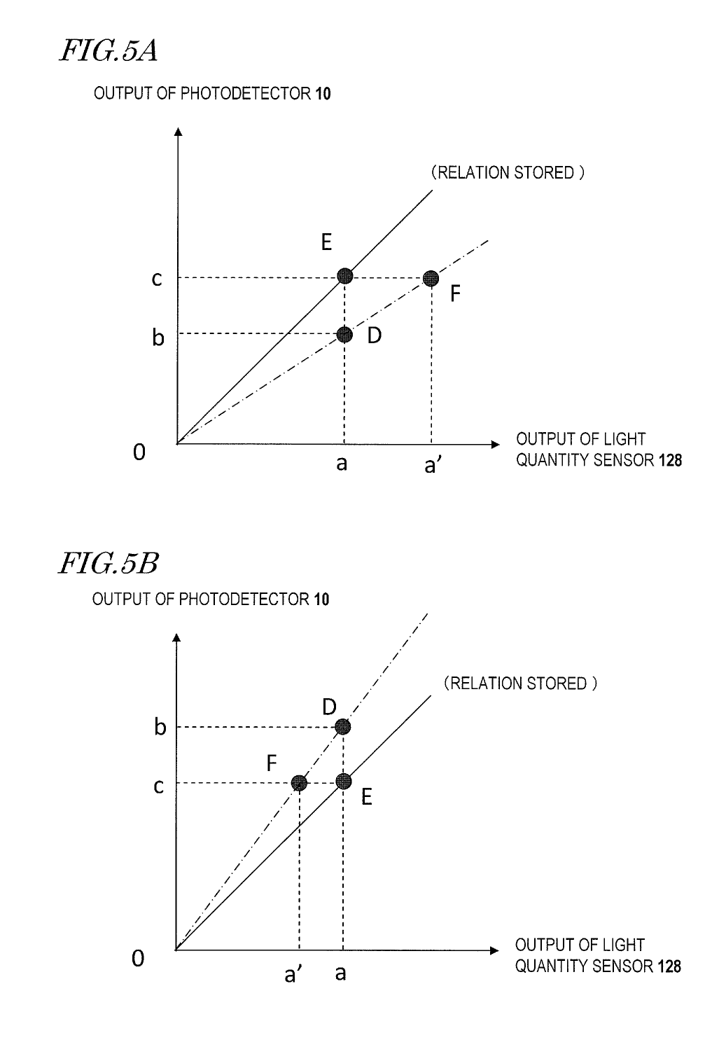

Next, it will be described with reference to FIG. 5(a) how a variation in the temperature of the light quantity sensor 128 may increase the output of the light quantity sensor 128 even if its output power is constant. In this example, the output of the light quantity sensor 128 of the laser light source 2 is supposed to have a value “a” and the output of the photodetector 10 is supposed to have a value “b”. The measured value obtained at that point in time is indicated by the point D in FIG. 5A. According to the relation shown in FIG. 4(c), when the output of the light quantity sensor 128 has the value “a”, the output of the photodetector 10 should have the value “c”. That is to say, the point D is not on the solid line that passes the origin and the point E. In that case, a formula representing the relation that is indicated by the one-dot chain that passes the origin and the point D is derived. Then, the amount of drive current supplied to the laser light source 2 is increased so that the output of the light quantity sensor 128 has a value “a′” (as indicated by the point F) with respect to the output value “c” of the photodetector 10 as shown in FIG. 4(c).

Optionally, in that case, if the values “b” and “c” satisfy the inequality

c−b≦k×c (where k is a positive constant)

then the output of the light quantity sensor 128 may be controlled to be equal to “a′”. On the other hand, if the values “b” and “c” satisfy the inequality

c−b>k×c (where k is a positive constant)

then the output of the light quantity sensor 128 may be controlled to be equal to “a”.

In this case, if k is set to be about 0.5, for example, then the control operation will be performed using only the output of the light quantity sensor 128 in a situation where the actually measured value “b” is a half or less of the value “c” obtained by the relation shown in FIG. 4(c). This means that if the actually measured value “b” becomes a half or less of the value “c” obtained by the relation shown in FIG. 4(c), then the stray light has decreased more than expected for some reason. In that case, the decrease in stray light will be regarded as having been caused by an instability factor, and the control operation will not be performed based on the output of the photodetector 10.

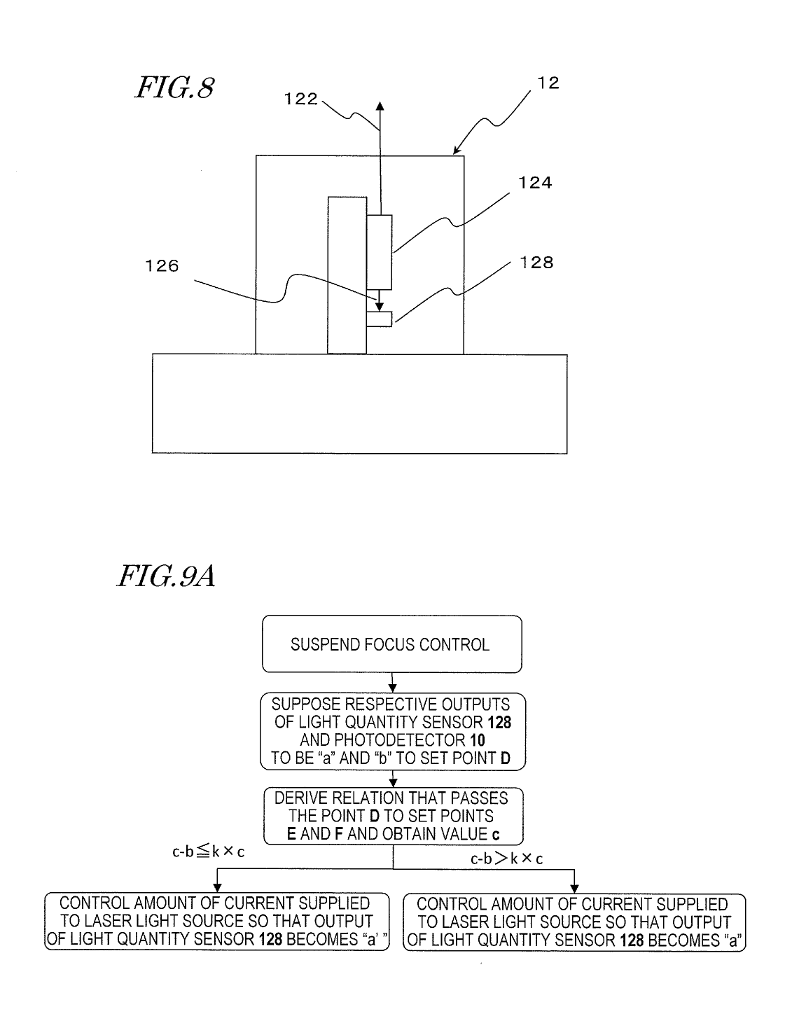

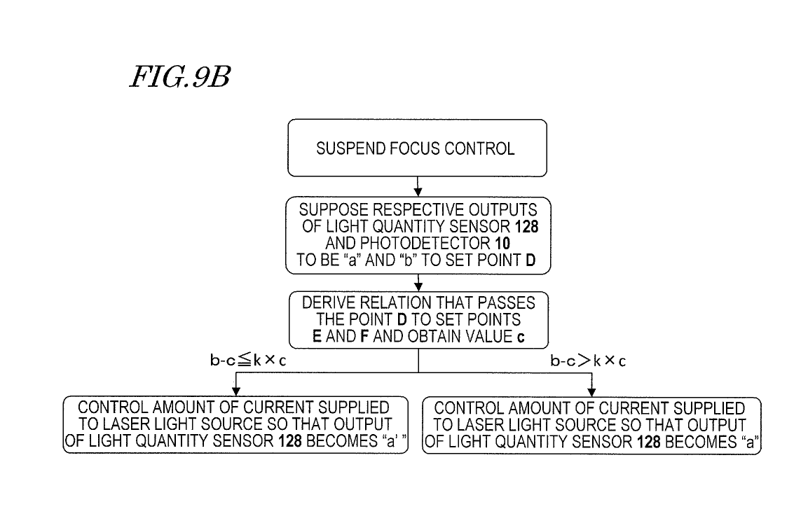

The procedure to follow in such a situation is shown as a flowchart in FIG. 9A.

Next, a situation where the output of the light quantity sensor decreases even though the power of the light emitted remains the same will be described with reference to FIG. 5(b). Such a situation will arise when the quantity of the light incident on the light quantity sensor decreases due to a deterioration of an end facet of the resonant cavity of a semiconductor laser diode.

In that case, the output of the light quantity sensor 128 of the laser light source 2 is supposed to have a value “a” and the output of the photodetector 10 is supposed to have a value “b”. The measured value obtained at that point in time is indicated by the point D in FIG. 5B. The point D is not on the solid line that passes the point E that satisfies the relation shown in FIG. 4(c). In that case, a formula representing the relation that is indicated by the one-dot chain that passes the point D is derived. Then, the amount of drive current supplied to the laser light source is controlled so that the output of the light quantity sensor 128 has a value “a′” (as indicated by the point F) with respect to the output value “c” of the optical signal detector as shown in FIG. 4(c).

Optionally, in that case, if the values “b” and “c” satisfy the inequality

b−c≦k×c (where k is a positive constant)

then the output of the light quantity sensor 128 may be controlled to be equal to “a′”. On the other hand, if the values “b” and “c” satisfy the inequality

b−c>k×c (where k is a positive constant)

then the output of the light quantity sensor 128 may be controlled to be equal to “a”.

In this case, if k is set to be about 0.5, for example, then the control operation will be performed using only the output of the light quantity sensor 128 in a situation where the actually measured value “b” is 1.5 or more times as large as the value “c” obtained by the relation shown in FIG. 4(c). This means that if the actually measured value “b” becomes 1.5 or more times as large as the value “c” obtained by the relation shown in FIG. 4(c), then the stray light has increased more than expected for some reason. In that case, the increase in stray light will be regarded as having been caused by an instability factor, and the control operation will not be performed based on the output of the photodetector 10.

The procedure to follow in such a situation is shown as a flowchart in FIG. 9B.

If the stray light to be incident on the photodetector 10 has increased or decreased more than expected for some reason, the instability factor can be eliminated by using only the output of the light quantity sensor 128 without using the output of the photodetector 10. Consequently, by setting k to be a desired value in this manner, the output power can be controlled with good stability.

It should be noted that an antireflective film is usually provided for each of optical members such as lenses and mirrors that form the optical system of an optical pickup. It will be an effective measure to take to increase the quantity of the stray light to be incident on the optical signal detector by removing that antireflective film. Without the antireflective film, the quantity of the stray light to be incident on the photodetector will increase and the control operation will be performed more precisely based on the output of the photodetector 10. Optionally, the surface of the housing that supports these optical members may be mirror-polished. By making such a finish, the quantity of the stray light to be incident on the photodetector can be increased.

In the preferred embodiments of the present invention described above, the laser light source 12 shown in FIG. 8 is supposed to be used. However, this is just an example of the present invention and the laser light source does not have to have such an arrangement. Alternatively, the laser light source may also be designed so that the light quantity sensor 128 in the laser light source detects a part of the light that has been emitted from the emissive end facet of the semiconductor laser diode 124.

### INDUSTRIAL APPLICABILITY

An optical disc drive according to the present invention can be used to write data on an optical disc not only with an optical pickup for reading and writing but also even with an inexpensive read-only optical pickup as well.

### REFERENCE SIGNS LIST

2 laser light source
4 beam splitter
8 objective lens
10 photodetector
30 optical pickup
36 preprocessor
37 controller
38 central processing unit
39 nonvolatile memory
40 system controller
41 driver
42 traverse motor
43 spindle motor
100 optical disc
101 optical axis
122 laser beam
124 semiconductor laser diode
126 laser beam
128 light quantity sensor
200 optical system
300 memory
400 control section

1. An optical disc drive comprising:
a laser light source for emitting a laser beam;
a photodetector for detecting a signal that has been supplied from an optical disc;
an optical system for irradiating the optical disc with the laser beam and guiding the light reflected from the optical disc to the photodetector;
a memory for storing information defining a relation between the output value of the photodetector and the output power of the laser light source when the laser light source is emitting the laser beam but the light reflected from the optical disc fails to reach the photodetector; and
a control section for controlling the output power of the laser light source based on the information stored in the memory and the output of the photodetector when the laser light source is emitting the laser beam but the light reflected from the optical disc fails to reach the photodetector.

2. The optical disc drive of claim 1, wherein the memory stores the output value of the photodetector when the laser beam is emitted by the laser light source but not focused on an information storage layer of the optical disc.

3. The optical disc drive of claim 1, wherein the memory stores the output value of the photodetector when the laser beam is emitted by the laser light source and when the drive is not loaded with the optical disc.

4. An optical disc drive comprising:
a laser light source for emitting a laser beam;
a light quantity sensor for detecting the power of the laser beam;
a photodetector for detecting a signal that has been supplied from an optical disc;
an optical system for irradiating the optical disc with the laser beam and guiding the light reflected from the optical disc to the photodetector;
a memory for storing not only information defining a relation between the output power of the laser light source and the output value of the photodetector but also information defining a relation between the respective outputs of the light quantity sensor and the photodetector when the laser light source is emitting the laser beam but the light reflected from the optical disc fails to reach the photodetector; and
a control section for controlling the output power of the laser light source based on the output of the light quantity sensor and the information stored in the memory.

5. The optical disc drive of claim 4, wherein the control section measures the output value of the photodetector at a certain timing when the laser light source is emitting the laser beam but the light reflected from the optical disc fails to reach the photodetector, and updates the information defining the relation between the respective outputs of the light quantity sensor and the photodetector.

6. The optical disc drive of claim 4, wherein if the output value of the light quantity sensor is “a” when the laser light source is emitting the laser beam with a first output power and when the light reflected from the optical disc fails to reach the photodetector,
the output of the photodetector should be “c” according to the information that is stored in the memory but is actually “b”,
in that case, if the difference between “b” and “c” is smaller than a predetermined value, then the output power of the laser light source is controlled so that the output of the light quantity sensor becomes “a′” with respect to the output “c” of the photodetector.

7. The optical disc drive of claim 6, wherein if the difference between “b” and “c” is greater than the predetermined value, then the output power of the laser light source is controlled so that the output of the light quantity sensor becomes “a”.

8. The optical disc drive of claim 4, wherein the laser light source includes a semiconductor laser diode that produces the laser beam and a package that covers the semiconductor laser diode, and
wherein the light quantity sensor is built in the package.
